(19) United States
(12) Patent Application Publication
(10) Pub. No.: US 2023/0243650 A1
(43) Pub. Date: Aug. 3, 2023

(54) RUGGEDIZED SENSOR DEVICES WITH DECREASED LIGHT SCATTER AND ASSOCIATED SYSTEMS AND METHODS

(71) Applicant: MineSense Technologies Ltd., Vancouver (CA)

(72) Inventors: Daniel Thomsson, Burnaby (CA); Manikaran Singh, Surrey (CA); Divyesh Rana, Vancouver (CA)

(21) Appl. No.: 18/163,779

(22) Filed: Feb. 2, 2023

Related U.S. Application Data
(60) Provisional application No. 63/305,874, filed on Feb. 2, 2022.

(51) Int. Cl. G01C 3/02

(52) U.S. Cl. CPC G01C 3/02

(57) ABSTRACT

Ruggedized sensor devices with decreased light scatter and associated methods and systems are disclosed herein. In some embodiments, a ruggedized sensor window apparatus includes a protective window and a light scatter blocking component positioned between the protective window and an optical sensor. The protective window is configured to intersect an optical path of a transmission component and a receiver component of the optical sensor. The light scatter blocking component is opaque and has a low reflection coefficient to block light scattering from a sender beam of the optical sensor from reaching the receiver component. The light scatter blocking component has an aperture extending completely through from a first side to a second side opposite the first side. The aperture is configured to be positioned over the transmission component of the optical sensor to allow transmission of the sender beam to pass therethrough.

### CROSS-REFERENCE TO RELATED APPLICATION(S)

The present application claims the benefit of U.S. Provisional Patent Application No. 63/305,874, filed Feb. 2, 2022, which is incorporated herein by reference in its entirety.

### TECHNICAL FIELD

The present disclosure generally relates to sensor systems used in harsh environments and, in particular, ruggedized sensor devices having decreased light scatter and associated methods and systems.

### BACKGROUND

Optical instruments, such as sensors, are typically made for use under relatively clean and safe conditions, where the optical components are kept free from dirt and particles. As an example, optical distance sensors often come with cleanliness requirements (e.g., cleanroom levels). When dust and dirt accumulate on the optical components of the sensor, the performance of the sensor reduces or the sensor malfunctions.

There are, however, applications in which it would be beneficial to use optical instruments under non-ideal conditions, such as the harsh environments of mining sites. In these environments, the optical instruments are exposed to debris that can interfere with the performance of such optical instruments. Thus, the optical instruments must be ruggedized to withstand the harsh environment, yet do so in a manner that doesn't interfere with the performance of the optical instrument itself.

### BRIEF DESCRIPTION OF THE DRAWINGS

Many aspects of the present disclosure can be better understood with reference to the drawings in the following Detailed Description. The components in the drawings are not necessarily to scale. Instead, emphasis is placed on clearly illustrating the principles of the present disclosure.

FIG. 1A is a partially exploded perspective view of a ruggedized sensor window apparatus configured in accordance with embodiments of the present technology.

FIGS. 1B and 1C are perspective and exploded views, respectively, of a sensor system including the ruggedized sensor window apparatus of FIG. 1A in accordance with embodiments of the present technology.

FIG. 2 is a perspective view of a light scatter blocking component configured in accordance with embodiments of the present technology.

FIGS. 3A and 3B are partially schematic cross-sectional drawings illustrating a sensor system without a ruggedized sensor window apparatus and a sensor system with a ruggedized sensor window apparatus, respectively, configured in accordance with embodiments of the present technology.

FIGS. 4A and 4B are perspective and plan views of a ruggedized sensor window apparatus configured in accordance with embodiments of the present technology.

FIG. 4C is a side view of a sensor system including the ruggedized sensor window apparatus of FIGS. 4A and 4B configured in accordance with embodiments of the present technology.

FIGS. 5A and 5B are partially schematic cross-sectional drawings illustrating a sensor system without a ruggedized sensor window apparatus and a sensor system with a ruggedized sensor window apparatus, respectively, configured in accordance with embodiments of the present technology.

FIGS. 6A-6D are perspective, cross-sectional perspective, plan, and cross-sectional side views of a ruggedized sensor window apparatus configured in accordance with embodiments of the present technology.

### DETAILED DESCRIPTION

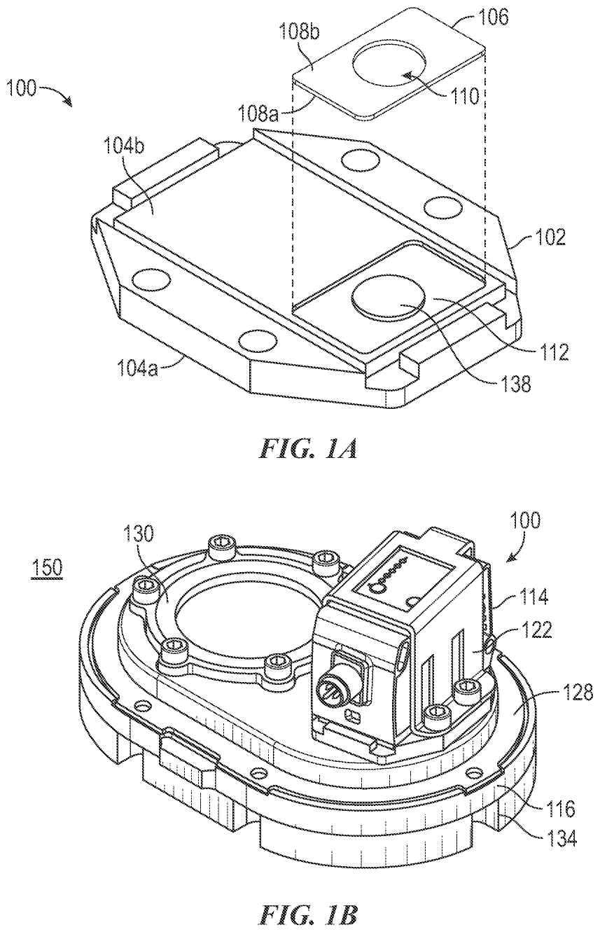

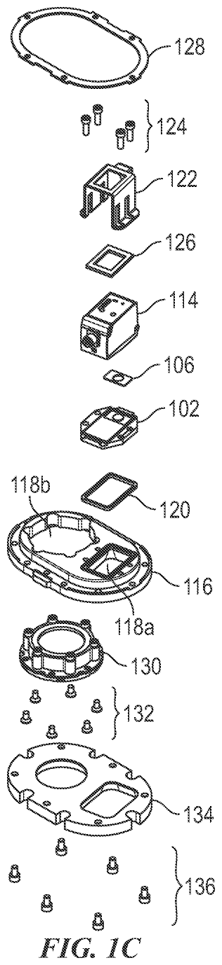

The present technology is directed generally to ruggedized sensor window devices for decreased light scatter and associated systems and methods. In some embodiments, for example, a ruggedized sensor window apparatus can include a light scatter blocking component positioned between a protective window and a sensor to prevent or reduce light scatter caused by debris on the protective window from interfering with the functionality of the optical components of the sensor. Specific details of several embodiments of the present technology are described herein with reference to FIGS. 1A-6D. The present technology, however, can be practiced without some of these specific details. In some instances, well-known structures and techniques often associated with optical sensors and mining equipment have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements can be arbitrarily enlarged to improve legibility. Component details can be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

FIG. 1A is a partially exploded perspective view of a ruggedized sensor window apparatus 100 (“apparatus 100”) configured in accordance with embodiments of the present technology, and FIGS. 1B and 1C are perspective and exploded views, respectively, of a sensor system 150 including the apparatus 100 of FIG. 1A in accordance with embodiments of the present technology. As shown in FIG. 1A, the apparatus 100 can include a protective window 102 having a first surface 104a (also referred to as a “front surface”) and a second surface 104b (also referred to as a “back surface”) opposite the first surface 104a, and a light scatter blocking component 106 (“blocking component 106”) positioned on the second surface 104b of the protective window 102. As shown in FIGS. 1B and 1C, the protective window 102 can be positioned forward of a sensor 114 such that the protective window 102 intersects an optical path of a transmission component and/or a receiver component of the sensor 114. The blocking component 106 has a first side 108a, a second side opposite the first side 108b, and an aperture 110 (also referred to as an opening, a hole, a lumen, a channel, or a passage) extending completely through the blocking component 106 from the first side 108a to the second side 108b. The blocking component 106 is positioned between the protective window 102 and the sensor 114 with the aperture 110 positioned over the transmission component of the sensor 114 to allow transmission of a sender beam to pass therethrough unobstructed. The blocking component 106 is configured to block light scatter caused by the protective window 102 and/or debris thereon from the sender beam from reaching the receiver component of the sensor 114.

The protective window 102 can be made from an optically transparent material that provides an optical path through which signals can be sent away from the sensor 114 and/or received by the sensor 114. In some embodiments, the protective window 102 is made from a durable material that is more robust than the sensor components themselves such that the protective window 102 can withstand impact (e.g., from rocks and/or other materials), debris built up (e.g., dust, dirt, mud), extreme temperatures (cold or hot), and/or other harsh environments commonly associated with mining sites. For example, the protective window 102 can be made from a polycarbonate material, an acrylic material, and/or other suitable sensor window materials.

As shown in FIGS. 1A and 1C, the protective window 102 includes a recessed portion 112 extending from the second surface 104b of the protective window 102 and configured (e.g., sized and shaped) to receive the blocking component 106. The recessed portion 112 provides a compartment that houses the blocking component 106 between the protective window 102 and the opposing sensor and restricts movement of the blocking component 106 relative to the sensor 114 and the protective window 102. As shown in the illustrated embodiment, a protrusion 138 extending upward from the recessed portion 112 and having a size, shape, and position corresponding to the aperture 110 of the blocking component 106. The protrusion 138 can extend to the same plane as the second surface 104b of the protective window 102 such that the protrusion of the protective window 102 can be positioned flush or adjacent to the transmission and/or receiving components of the sensor 114 (e.g., adjacent to a sensor window). In some embodiments, the protective window can include different and/or additional features that restrict movement of the blocking component 106. The recessed portion 112 also avoids the blocking component 106 from applying undue compression pressure on the sensor 114 and/or the protective window 102 when the sensor system 150 is assembled. In some embodiments, the protective window 102 does not include the recessed portion 112 and the blocking component extends along all or a portion of the second surface 104b of the protective window 102. In some embodiments, the protective window 102 and the blocking component 106 form an integral unit that is subsequently attached to the sensor 114.

The blocking component 106 can be made from a material that includes properties for decreasing, preventing, and/or blocking light scatter. For example, the blocking component 106 can be made from an opaque material that has a low reflection coefficient for at least the wavelength(s) emitted by the sensor 114. The blocking component 106 may also be made from a soft and/or pliable material that avoids scratching or otherwise damaging the surface of the protective window 102 and/or the face of the sensor 114 (e.g., the window through which the sensor 114 transmits or receives signals). In some embodiments, for example, the blocking component 106 can be made from a sheet of ethylene propylene diene monomer (EPDM), which is a soft and opaque rubber material that can retain its properties over a wide range of temperatures and has a low reflection coefficient for the wavelengths at which the sensor 114 operates. In some embodiments, the blocking component 106 can be made from black polylactic acid (PLA) via additive manufacturing (e.g., 3D-printed) and/or other opaque materials that have a low reflection coefficient at the sensor's operating wavelength.

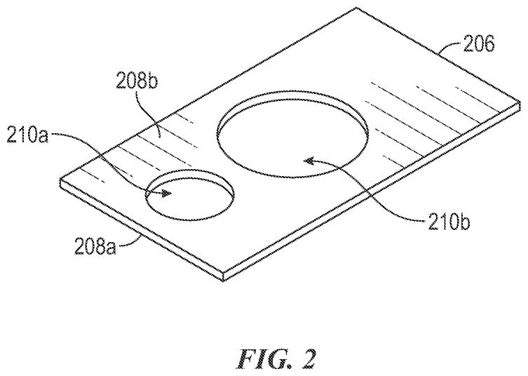

The blocking component 106 is positioned between at least a portion of the protective window 102 and the sensor 114 such that the blocking component 106 does not interfere with signals emitted from and or received the sensor 114 (e.g., signals transmitted/received to/from beyond the first surface 104a of the protective window 102), and includes at least a portion between the transmission component and the receiver component of the sensor 114 to block or otherwise prevent incident light scatter from the emitted signals of the transmission component from being received by the receiver component. In the illustrated embodiment, the blocking component 106 is positioned across only a portion of the protective window 102 (e.g., in the region surrounding the transmission component) with the aperture 110 positioned over the transmission component of the sensor 114 to allow signals to pass therethrough. In the illustrated embodiment, the aperture 110 has a circular cross section, whereas in other embodiments the aperture 110 may have a polygonal, oval, irregular, and/or other suitable cross-sectional shape that may be dictated by the size and shape of the components of the sensor 114. In some embodiments, the blocking component 106 may extend across a larger portion of the protective window 102 (e.g., extending across the front face of the sensor 114) and, as described in further detail below with respect to FIG. 2, may include a separate aperture associated with the receive component of the sensor 114. In some embodiments, the blocking component 106 does not include an aperture and is instead a substrate (e.g., a strip of material) positioned in the lateral space between the transmission and receiver components of the sensor 114.

The sensor 114 can include one or more sensing devices that sends and/or receives signals. In some embodiments, for example, the sensor 114 is a distance sensor (e.g., a laser distance sensor) that can measure the distance between the sensor and a target using lasers. In some embodiments, the sensor 114 can include one or more cameras that can detect material characteristics and/or other parameters, x-ray fluorescence (XRF) emitters, XRF detectors, ultrasonic distance sensors, lidar distance sensors, multi-spectral imaging cameras, flash tubes, hyperspectral imaging cameras, stereoscopic cameras, radiation detectors, electromagnetic detectors, gamma-ray source sensors, optical sensors, and/or other sensor devices. In some embodiments, the sensor 114 can include a multispectral or hyperspectral imaging head as described in U.S. patent application Ser. No. 17/992,626, entitled COMPOSITIONAL MULTISPECTRAL AND HYPERSPECTRAL IMAGING SYSTEMS FOR MINING SHOVELS AND ASSOCIATED METHODS, filed Nov. 22, 2022, and which is incorporated by reference in its entirety.

The ruggedized sensor system 150 can provide an assembly that encloses at least a portion of the sensor 114. Referring to FIG. 1C, for example, the sensor system 150 can include a housing 116 with a first housing aperture 118a behind which the protective window 102 can be positioned, and a first seal member 120 therebetween. The first housing aperture 118a allows unobstructed transmission of signals (e.g., transmission signals) to and/or from the sensor 114 via the protective window 102. The first seal member 120 can block dust and dirt from penetrating the first housing aperture 118a and/or cushion the protective window 102 from the more rigid surface of the housing 116. A clamp component 122 can extend around the sensor 114 and couple to the back side of the housing 116 via fasteners 124 to secure the sensor 114 to the housing 116, and an optional buffer member 126 can be positioned therebetween to cushion or otherwise protect the sensor 114 during operation (e.g., mining activity with high frequency vibrations). The buffer 126 can be made from a material that is resilient to high temperature and soft, such as silicone foam. A second seal member 128 can be positioned along a perimeter of the housing 116. In some embodiments, the sensor 114 can be secured to the housing 116 using additional and/or other suitable connection mechanisms.

As further shown in FIG. 1C, a window assembly 130 can be at least partially within a second housing aperture 118b of the housing 116 and secured thereto with one or more fasteners 132. A guard 134 made of strong, impact-resistant material is secured to the front side of the housing 116 via one or more fasteners 136 such that the guard 134 can further protect the housing 116 and the underlying sensor components during operation. The guard 134 has a first guard aperture 138a aligned with the first housing aperture 118a to allow unobstructed transmission of signals to and from the sensor 114, and a second guard aperture 138b aligned with another sensing component and/or other transmission component (e.g., an XRF sensor, and XRF emitter, a laser emissions component) positioned behind the window assembly 130 and the second housing aperture 118b. In other embodiments, the sensor system 150 can include additional components, some components may be omitted, and/or the components of the system 150 can have other suitable shapes and sizes for the sensor(s) it is meant to protect and/or the specific application (e.g., placement on a mining shovel bucket, placement on the arm of a mining shovel bucket, placement on other equipment at a mining site or other harsh environment).

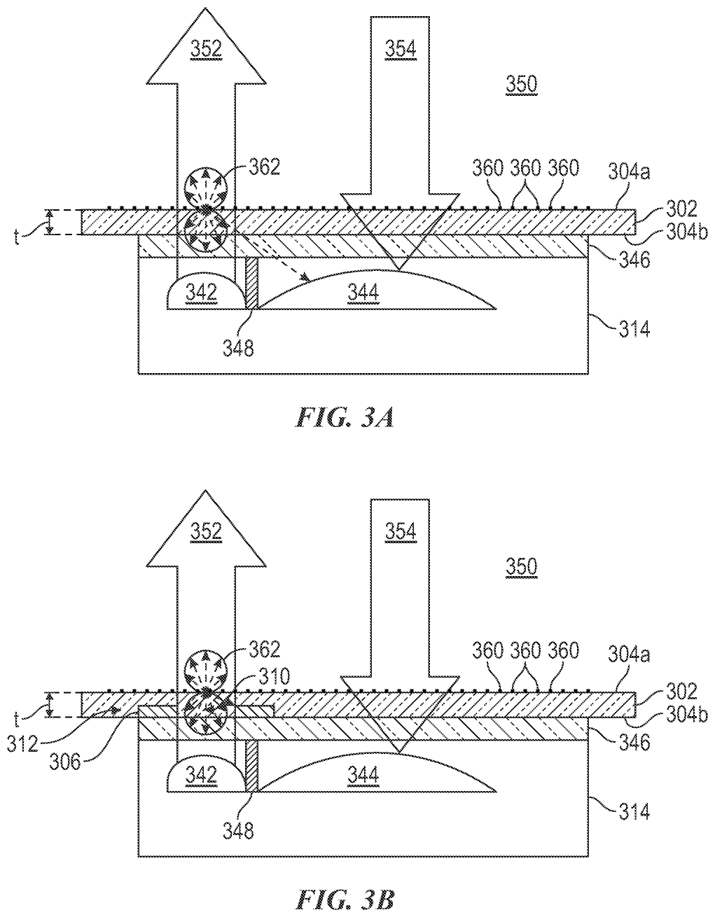

As described further below with reference to FIGS. 3A and 3B, the system 150 with the protective window 102 and blocking component 106 reduces or eliminates back scattered light from the protective window 102 reaching the receiving component of the sensor 114. This reduces or eliminates the sensor sensitivity to accumulated dust, mud, and/or other debris on the protective window 102, which accumulates when used in rugged conditions, such as mining environment. Accordingly, the protective window assembly with the blocking component 106 can improve the accuracy of the sensor 114, reduce the number of false readings or missed pulses of the sensor, and/or reduce the downtime of the system by improving the triggering reliability of the sensor 114. As such, the assembly provides a robust protective housing allowing the sensor 114 to be used in inhospitable conditions. For example, the sensor assembly can be mounted on various portions of machinery used at a mining site, such as on front-end loaders, hydraulic excavators, cable and/or rope mining buckets, and/or other mining site machinery, while still preserving the sensor's integrity when scanning the mineral content of the bucket and allowing for accurate assessment of the grade, composition, distance, and/or other features of the material therein during and/or after loading.

FIG. 2 is a perspective view of a light scatter blocking component 206 (“blocking component 206”) configured in accordance with embodiments of the present technology. The blocking component 206 includes several features generally similar to the blocking component 106 described above with respect to FIGS. 1A-1C. For example, the blocking component 206 is configured to block light scatter from a transmitted sensor signal from reaching a receiver component of a sensor (e.g., the sensor 114 of FIGS. 1A-1C). The blocking component 206 can be made from a material that is opaque for decreasing light scatter, and soft for minimizing the risk of scratching either the protective window 102 or the window of the sensor 114. For example, the blocking component 206 can be made from a sheet of ethylene propylene diene monomer (EPDM) or 3D-printed using black polylactic acid (PLA).

In the illustrated embodiment, the blocking component 206 has not one, but two apertures 210 (identified individually as a first aperture 210a and a second aperture 210b) extending from a first side 208a of the blocking component 206 to an opposing second side 208b of the blocking component. The first aperture 210a is sized and shaped to be positioned over a transmission component and/or receiver component of a sensor, and the second aperture 210b is sized and shaped to be positioned over the other of the transmission component and/or receiver component of the sensor. In the illustrated embodiment, the first aperture 210a has a smaller cross-sectional dimension (e.g., diameter) than the second aperture 210b, and the two apertures 210 are laterally spaced apart though aligned along a longitudinal axis of the blocking component 206. In other embodiments, the apertures 210 may be sized and/or shaped differently, may be the same size, and/or may extend along different axes along the face of the blocking component 206 (e.g., non-aligned, offset) depending on the configuration of the underlying sensor. Such dual aperture blocking components 206 can be of use with sensors that have transmission and receiver components spaced laterally apart from each other. In some embodiments, the blocking component 206 has more than two apertures to accommodate various sensor configurations and/or associated components.

FIGS. 3A and 3B are partially schematic cross-sectional drawings illustrating a sensor system 350 without a ruggedized sensor window apparatus and a sensor system 350 with a ruggedized sensor window apparatus 300, respectively, configured in accordance with embodiments of the present technology. The sensor system 350 includes several features generally similar to the sensor system 150 described above with respect to FIGS. 1A-1C. Referring to both FIGS. 3A and 3B, the sensor system 350 includes a sensor 314 with a transmission component 342 configured to emit a sender beam 352 towards a target, a receiver component 344 configured to receive light reflected off the target 354, and a sensor window 346. The sensor system 350 can also include an opaque divider 348 positioned between the transmission component 342 and the receiver component 344 and configured to block a portion of light scattering (e.g., light scattering caused when the sender beam 352 passes through the sensor window 346).

In the illustrated embodiments, a protective window 302 is positioned proximate to (e.g., flush or nearly flush with) the sensor window 346. The protective window 302 has a first surface 304a (also referred to as a “front surface”), a second surface 304b (also referred to as a “back surface”) opposite the first surface 304a, and a thickness t (e.g., 4 mm, 6 mm, 8 mm) that varies depending on operation requirements (e.g., robustness, sizing constraints) and the material of the protective window 302 (e.g., polycarbonate does not have shatter failure, sapphire coated glass can shatter). In operation, dust, mud, and other particles 360 (“dust 360”) can buildup on the first surface 304a of the protective window 302. The dust 360 can increase the number of false readings or missed pulses of the sensor 314, increase the downtime of the sensor system 350 by lowering the triggering reliability of the sensor 314, and/or otherwise cause errors and data loss. For example, the dust 360 can cause the sensor 314 to confuse the dust 360 with the intended target beyond the protective window 302. Although some sensors can have a discrimination threshold to disregard readings that are within a minimum distance (e.g., the distance between the sensor 314 and the protective window 302, 50 mm), the dust 360 can still cause errors and reduce the detection range of the sensor 314 by weakening transmission of the sender beam 352 from the transmission component 342 and/or the light reflected off the target 354 directed towards the receiver component 344. In another example, the dust 360 can cause back scattered light 362 when the sender beam 352 passes through the first surface 304a of the protective window 302, which can reach the receiver component 344. Some mining equipment rely on triggering by sensors (e.g., distance sensors) to initiate data collection and inaccurate timing can cause deterioration in the performance of the mining equipment.

The ruggedized sensor window apparatus 300 illustrated in FIG. 3B includes a blocking component 306 positioned in a recessed portion 312 on the second surface 304b of the protective window 302. The blocking component 306 includes an aperture 310 extending completely through to allow the sender beam 352 to pass through unobstructed. The blocking component 306 is configured to reduce or eliminate back scattered light from the protective window 302 reaching the receiving component 344 of the sensor 314. As shown in FIG. 3A, if the sensor system 350 lacks a ruggedized sensor window apparatus 300, back scattered light 362 can reach the receiver component 344 even when the divider 348 is present, potentially causing errors and/or data loss. However, as shown in FIG. 3B, if the sensor system 350 includes the ruggedized sensor window apparatus 300, the blocking component 306 prevents the back scattered light 362 from reaching the receiver component 344. In some embodiments, the protective window 302 does not include the recessed portion 312 and the blocking component 306 extends along all or a portion of the second surface 304b of the protective window 302. In some embodiments, the protective window 302 and the blocking component 306 form an integral unit that is subsequently attached to the sensor 314.

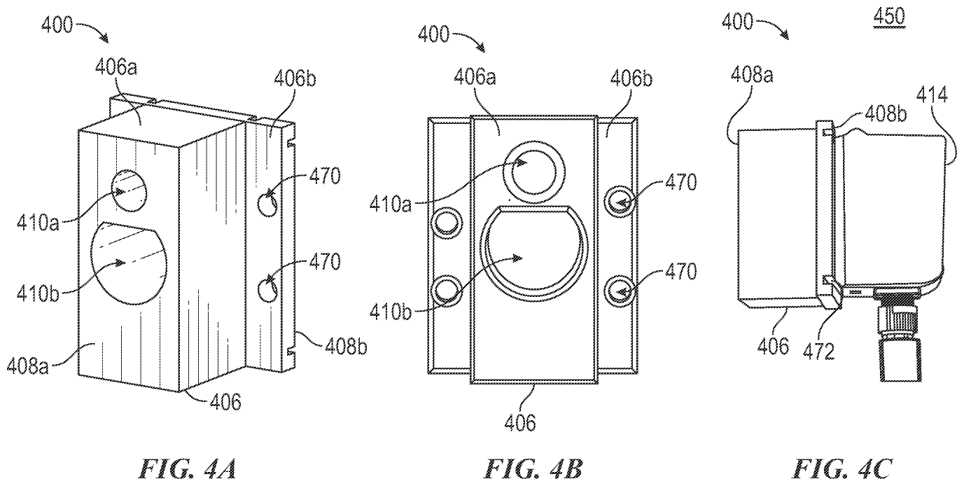

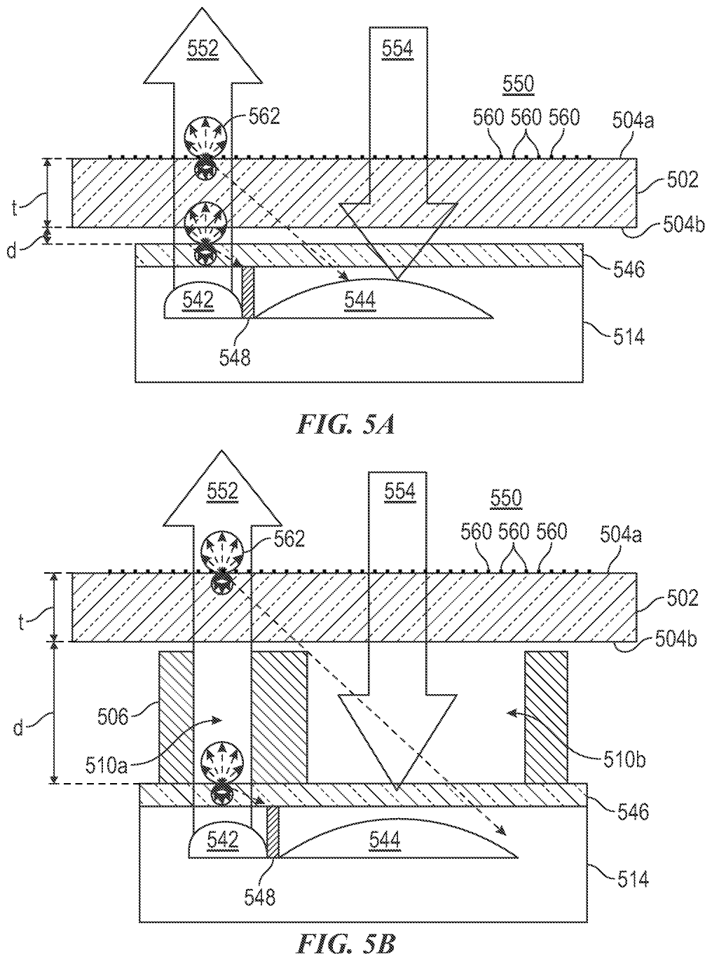

FIGS. 4A and 4B are perspective and plan views of a ruggedized sensor window apparatus 400 (“apparatus 400”) configured in accordance with embodiments of the present technology. The apparatus 400 includes several features generally similar to the apparatus 100 described above with respect to FIGS. 1A-1C. The apparatus 400 includes a blocking component 406 with an extruded portion 406a and one or more side guides 406b. The blocking component 406 includes two apertures 410 (identified individually as a first aperture 410a and a second aperture 410b) extending from a first side 408a of the blocking component 406 to an opposing second side 408b of the blocking component. The first aperture 410a is sized and shaped to be positioned over a transmission component and/or receiver component of a sensor (e.g., sensor 414 illustrated in FIG. 4C), and the second aperture 410b is sized and shaped to be positioned over the other of the transmission component and/or receiver component of the sensor. In the illustrated embodiment, the first aperture 410a has a smaller cross-sectional dimension (e.g., diameter) than the second aperture 410b, and the two apertures 410 are laterally spaced apart. In other embodiments, the apertures 410 may be sized and/or shaped differently, may be the same size, and/or may extend along different axes along the face of the blocking component 406 (e.g., non-aligned, offset) depending on the configuration of the underlying sensor. In some embodiments, the blocking component 406 has more than two apertures to accommodate various sensor configurations and/or associated components.

The blocking component 406 can be positioned between a protective window and a sensor with the first aperture 410a positioned over the transmission component of the sensor to allow transmission of the sender beam to pass therethrough unobstructed, and with the second aperture 410b positioned over the receiver component of the sensor to allow transmission of light reflected off a target to pass therethrough unobstructed. The extruded portion 406a can be positioned in a recessed portion of the protective window or extend along all or a portion of the protective window. The one or more side guides 406b are configured to facilitate attachment of the blocking component 406 to the protective window and includes a plurality of holes 470 configured to receive fasteners. In some embodiments, the protective window and the blocking component 406 form an integral unit that is subsequently attached to the sensor.

FIG. 4C is a side view of a sensor system 450 including the ruggedized sensor window apparatus 400 of FIGS. 4A and 4B configured in accordance with embodiments of the present technology. As shown, the sensor 414 interfaces with the second side 408b of the blocking component 406 such that the transmission component of the sensor 414 aligns with the first aperture 410a and the receiver component of the sensor 414 aligns with the second aperture 410b. The blocking component 406 further includes grooves 472 configured to mate with other components of the sensor system 450 (e.g., a clamp component configured to secure the sensor 414 to the blocking component 406, the protective window, and/or a housing).

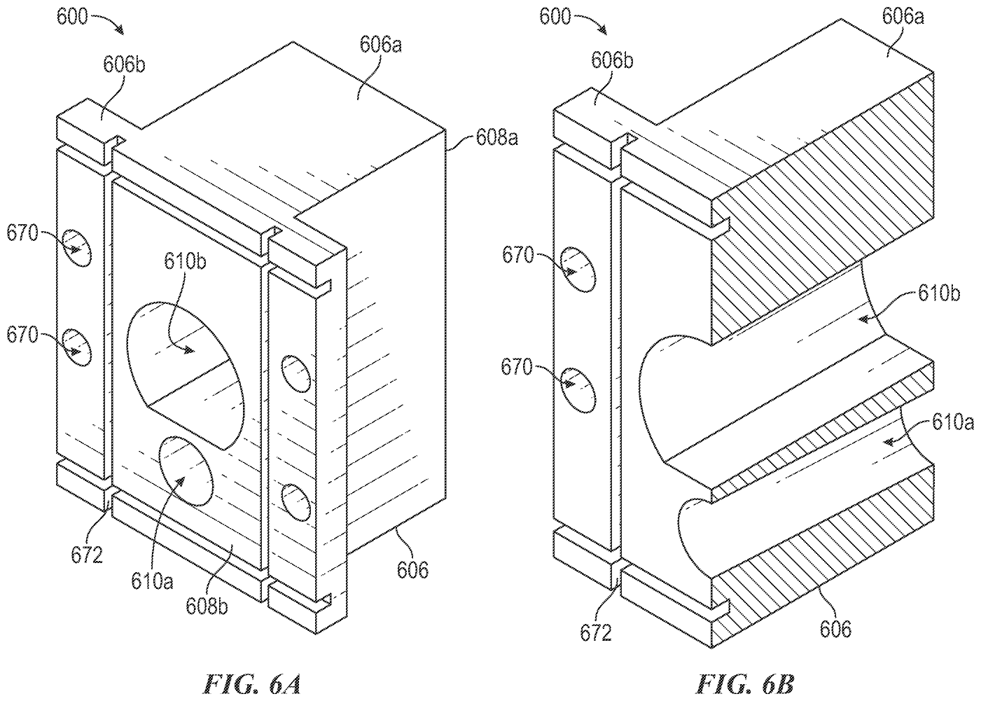

FIGS. 5A and 5B are partially schematic cross-sectional drawings illustrating a sensor system 550 without a ruggedized sensor window apparatus and a sensor system 550 with a ruggedized sensor window apparatus 500, respectively, configured in accordance with embodiments of the present technology. The sensor system 550 includes several features generally similar to the sensor system 150 described above with respect to FIGS. 1A-1C. Referring to both FIGS. 5A and 5B, the sensor system 550 includes a sensor 514 with a transmission component 542 configured to emit a sender beam 552 towards a target, a receiver component 544 configured to receive light reflected off the target 554, and a sensor window 546. The sensor system 550 can also include an opaque divider 548 positioned between the transmission component 542 and the receiver component 544 and configured to block a portion of light scattering (e.g., light scattering caused when the sender beam 552 passes through the sensor window 546).

In the illustrated embodiments, a protective window 502 is spaced apart from the sensor window 546 by a distance d. The distance d can serve to accommodate a blocking component 506 and/or other components, due to the operating parameters of the sensor 514, and/or due to the dimensions of the sensor 514 and/or surrounding structures. The protective window 502 has a first surface 504a (also referred to as a “front surface”), a second surface 504b (also referred to as a “back surface”) opposite the first surface 504a, and a thickness t that varies depending on operation requirements (e.g., robustness, sizing constraints) and the material of the protective window 502 (e.g., polycarbonate does not have shatter failure, sapphire coated glass can shatter). In some embodiments, the sensor system 550 can include a self-cleaning window as described in U.S. patent application Ser. No. 17/992,657, entitled SELF-CLEANING SENSOR WINDOW DEVICES FOR MINE SITE EQUIPMENT AND ASSOCIATED SYSTEMS AND METHODS, filed Nov. 22, 2022, and which is incorporated by reference in its entirety.

In operation, dust, mud, and other particles 560 (“dust 560”) can buildup on the first surface 504a of the protective window 502. The dust 560 can increase the number of false readings or missed pulses of the sensor 514, increase the downtime of the sensor system 550 by lowering the triggering reliability of the sensor 514, and/or otherwise cause errors and data loss. For example, the dust 560 can reduce (i.e., weaken) transmission of the sender beam 552 from the transmission component 542 and/or the light reflected off the target 554 directed towards the receiver component 544. In another example, the dust 560 can cause back scattered light 562 when the sender beam 552 passes through the first surface 504a of the protective window 502, which can reach the receiver component 544.

The ruggedized sensor window apparatus 500 illustrated in FIG. 5B includes a blocking component 506 positioned between the protective window 502 and the sensor window 546. The blocking component 506 includes a first aperture 510a extending completely through to allow the sender beam 552 to pass through unobstructed and a second aperture 510b extending completely through to allow the light reflected off the target 554 to reach the receiver component 544 unobstructed. The blocking component 506 is configured to reduce or eliminate back scattered light from the protective window 502 reaching the receiving component 544 of the sensor. As shown in FIG. 5A, if the sensor system 50 lacks a ruggedized sensor window apparatus 500, back scattered light 562 can reach the receiver component 544 even when the divider 548 is present, potentially causing errors and/or data loss. However, as shown in FIG. 5B, if the sensor system 550 includes the ruggedized sensor window apparatus 500, the blocking component 506 prevents the back scattered light 562 from reaching the receiver component 544. In some embodiments, the protective window 502 includes a recessed portion in which all or a portion of the blocking component 506 is configured to fit. In some embodiments, the protective window 502 and the blocking component 506 form an integral unit that is subsequently attached to the sensor 514.

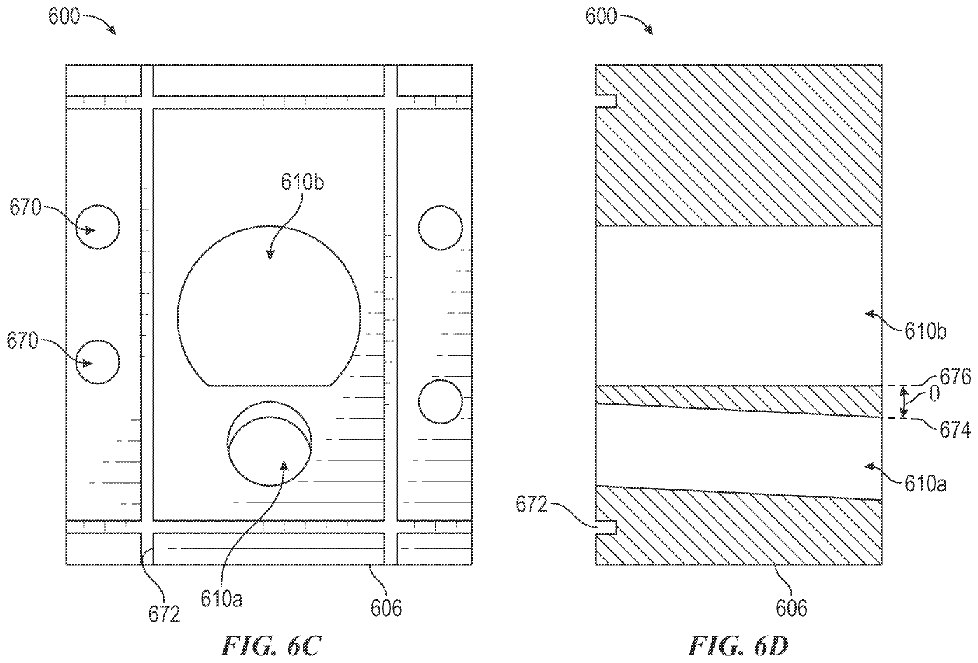

FIGS. 6A-6D are perspective, cross-sectional perspective, plan, and cross-sectional side views of a ruggedized sensor window apparatus 600 (“apparatus 600”) configured in accordance with embodiments of the present technology. The apparatus 600 includes several features generally similar to the apparatus 100 described above with respect to FIGS. 1A-1C. The apparatus 600 includes a blocking component 606 with an extruded portion 606a and one or more side guides 606b. The extruded portion 606a has two apertures 610 (identified individually as a first aperture 610a and a second aperture 610b) extending from a first side 608a of the blocking component 606 to an opposing second side 608b of the blocking component. The first aperture 610a is sized and shaped to be positioned over a transmission component and/or receiver component of a sensor, and the second aperture 610b is sized and shaped to be positioned over the other of the transmission component and/or receiver component of the sensor. In the illustrated embodiment, the first aperture 610a has a smaller cross-sectional dimension (e.g., diameter) than the second aperture 610b, and the two apertures 610 are laterally spaced apart. The first aperture 610a extends along a first axis 674 and the second aperture 610b extends along a second axis 676. The first and second axes 674 and 676 can be offset by an angle θ (e.g., 1 degree, 2 degrees, 3 degrees, 4 degrees, 5 degrees, 10 degrees). In other embodiments, the apertures 610 may be sized and/or shaped differently, may be the same size, and/or may extend along different axes along the face of the blocking component 606 (e.g., parallel, offset in other directions) depending on the configuration of the underlying sensor. In some embodiments, the blocking component 606 has more than two apertures to accommodate various sensor configurations and/or associated components. The blocking component 606 can further include grooves 672 configured to mate with other components of the sensor system (e.g., a clamp configured to secure the sensor to the blocking component 606 and/or the protective window).

The blocking component 606 can be positioned between a protective window and the sensor. The extruded portion 606a can be positioned in a recessed portion of the protective window or extend along all or a portion of the protective window. The one or more side guides 606b are configured to facilitate attachment of the blocking component 606 to the protective window and includes a plurality of holes 670 configured to receive fasteners. In some embodiments, the protective window and the blocking component 606 form an integral unit that is subsequently attached to the sensor.

### Further Examples

The following examples are illustrative of several embodiments of the present technology:
1. A ruggedized sensor window apparatus, comprising:
a protective window having a first surface and a second surface opposite the first surface, wherein the protective window is configured to be positioned forward of an optical sensor intersecting an optical path of a transmission component and a receiver component of the optical sensor;
a light scatter blocking component on the second surface of the protective window and configured to be positioned between the protective window and the optical sensor, wherein the light scatter blocking component has a first side, a second side opposite the first side, and an aperture extending completely through the light scatter blocking component from the first side to the second side, wherein the aperture is configured to be positioned over the transmission component of the optical sensor to allow transmission of a sender beam to pass therethrough,
and
wherein the light scatter blocking component is opaque and has a low reflection coefficient to block light scattering from the sender beam from reaching the receiver component of the optical sensor.
2. The ruggedized sensor window apparatus of any one of the preceding examples wherein the light scatter blocking component comprises ethylene propylene diene monomer (EPDM).
3. The ruggedized sensor window apparatus of any one of the preceding examples wherein the light scatter blocking component comprises black polylactic acid (PLA).
4. The ruggedized sensor window apparatus of any one of the preceding examples wherein the aperture is a first aperture, and wherein the light scatter blocking component further comprises:
a second aperture extending through the light scatter blocking component from the first side to the second side, wherein the second aperture is configured to be positioned over the receiver component of the optical sensor to allow the receiver component to detect reflected light,
wherein the second aperture is spaced laterally apart from the first aperture by a distance.
5. The ruggedized sensor window apparatus of example 4 wherein:
the first aperture extends along a first axis; and
the second aperture extends along a second axis, wherein the first and second axes are parallel to each other.
6. The ruggedized sensor window apparatus of example 4 wherein:
the first aperture extends along a first axis; and
the second aperture extends along a second axis, wherein the first and second axes are not parallel to each other.
7. The ruggedized sensor window apparatus of any one of the preceding examples wherein the protective window comprises protective polycarbonate.
8. The ruggedized sensor window apparatus of any one of the preceding examples wherein:
the protective window is a thin substrate configured to avoid light scatter; and
the protective window and the light scatter blocking component are configured to be positioned in physical contact with the optical sensor.
9. The ruggedized sensor window apparatus of example 8 wherein the protective window has a thickness of at most 8 mm.
10. The ruggedized sensor window apparatus of any one of the preceding examples wherein:
the protective window has a recessed portion surrounding the transmission component; and
the light scatter blocking component is positioned in the recessed portion.
11. The ruggedized sensor window apparatus of any one of the preceding examples wherein:
the protective window is spaced apart from the sensor by a distance; and
the light scatter blocking component has a thickness defined by the distance between the protective window and a front surface of the optical sensor.
12. The ruggedized sensor window apparatus of any one of the preceding examples wherein the protective window has a thickness of at least 10 mm.
13. A ruggedized sensor assembly, comprising:
a sensor having a transmission component and a receiver component;
a protective window positioned forward of the transmission and receiver components of the sensor, wherein the protective window is optically transparent;
a light scatter blocking component between at least a portion of the sensor and protective window, wherein the light scatter blocking has an aperture positioned surrounding the transmission component to allow transmission of signals therefrom, and wherein the light scatter blocking component is configured to block scatter from the transmission component from reaching the receiver component.
14. The ruggedized sensor assembly of any one of the preceding examples wherein the sensor is a laser distance sensor.
15. The ruggedized sensor assembly of any one of the preceding examples wherein:
the protective window comprises a recessed portion; and
the light scatter blocking component is positioned within the recessed portion.
16. The ruggedized sensor assembly of any one of the preceding examples wherein the window comprises polycarbonate.
17. The ruggedized sensor assembly of any one of the preceding examples wherein the window has a thickness between 4 mm and 8 mm.
18. The ruggedized sensor assembly of any one of the preceding examples wherein the window has a thickness between 8 mm and 20 mm.
19. The ruggedized sensor assembly of any one of the preceding examples wherein the aperture is a first aperture, wherein the light scatter blocking component has a second aperture extending through from the first side to the second side, and wherein the second aperture is configured to allow reflected light to reach a receiver of the sensor.
20. The ruggedized sensor assembly of any one of the preceding examples wherein the first aperture extends along a first axis, the second aperture extends along a second axis, and the first axis and the second axis are offset from each other by an angle between 1 degree and 5 degrees.
21. A method of ruggedizing a sensor, the method comprising:
positioning a protective window forward of the sensor intersecting an optical path of a transmission component and a receiver component of the sensor; and
positioning a light scatter blocking component between the protective window and the sensor, wherein the light scatter blocking component has a first side and a second side opposite the first side, and wherein the light scatter blocking component has an aperture extending completely through the light scatter blocking component from the first side to the second side,
wherein the aperture is configured to be positioned over the transmission component of the sensor to allow transmission of a sender beam to pass therethrough, and
wherein the light scatter blocking component is opaque and has a low reflection coefficient to block light scattering from the sender beam from reaching the receiver component of the sensor.
22. The method of any one of the preceding examples wherein:
the protective window has a recessed portion surrounding the transmission component; and
the light scatter blocking component is positioned in the recessed portion.
23. The method of any one of the preceding examples wherein the light scatter blocking component comprises ethylene propylene diene monomer (EPDM) or black polylactic acid (PLA).
24. The method of any one of the preceding examples wherein the aperture is a first aperture, and wherein the light scatter blocking component further comprises:
a second aperture extending through the light scatter blocking component from the first side to the second side, wherein the second aperture is configured to be positioned over the receiver component of the optical sensor to allow the receiver component to detect reflected light, wherein the second aperture is spaced laterally apart from the first aperture by a distance.
25. The method of any one of the preceding examples wherein the first aperture extends along a first axis, the second aperture extends along a second axis, and the first axis and the second axis are offset from each other by an angle between 1 degree and 5 degrees.

### CONCLUSION

In general, the detailed description of embodiments of the present technology is not intended to be exhaustive or to limit the invention to the precise form disclosed above. While specific embodiments of, and examples for, the present technology are described above for illustrative purposes, various equivalent modifications are possible within the scope of the present technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the present technology provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the present technology can be modified, if necessary, to employ the systems, functions, and concepts of the various references described above to provide yet further embodiments of the present technology.

These and other changes can be made to the present technology in light of the above Detailed Description. While the above description details certain embodiments of the present technology and describes the best mode contemplated, no matter how detailed the above appears in text, the present technology can be practiced in many ways. Details of the present technology may vary considerably in its implementation details, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific embodiments disclosed in the specification, unless the above Detailed Description section explicitly defines such terms. Accordingly, the actual scope of the invention encompasses not only the disclosed embodiments, but also all equivalent ways of practicing or implementing the present technology.

I/We claim:

1. A ruggedized sensor window apparatus, comprising:
a protective window having a first surface and a second surface opposite the first surface, wherein the protective window is configured to be positioned forward of an optical sensor intersecting an optical path of a transmission component and a receiver component of the optical sensor;
a light scatter blocking component on the second surface of the protective window and configured to be positioned between the protective window and the optical sensor, wherein the light scatter blocking component has a first side, a second side opposite the first side, and an aperture extending completely through the light scatter blocking component from the first side to the second side, wherein the aperture is configured to be positioned over the transmission component of the optical sensor to allow transmission of a sender beam to pass therethrough,
and
wherein the light scatter blocking component is opaque and has a low reflection coefficient to block light scattering from the sender beam from reaching the receiver component of the optical sensor.

2. The ruggedized sensor window apparatus of claim 1 wherein the light scatter blocking component comprises ethylene propylene diene monomer (EPDM).

3. The ruggedized sensor window apparatus of claim 1 wherein the light scatter blocking component comprises black polylactic acid (PLA).

4. The ruggedized sensor window apparatus of claim 1 wherein the aperture is a first aperture, and wherein the light scatter blocking component further comprises:
a second aperture extending through the light scatter blocking component from the first side to the second side, wherein the second aperture is configured to be positioned over the receiver component of the optical sensor to allow the receiver component to detect reflected light,
wherein the second aperture is spaced laterally apart from the first aperture by a distance.

5. The ruggedized sensor window apparatus of claim 4 wherein:
the first aperture extends along a first axis; and
the second aperture extends along a second axis, wherein the first and second axes are parallel to each other.

6. The ruggedized sensor window apparatus of claim 4 wherein:
the first aperture extends along a first axis; and
the second aperture extends along a second axis, wherein the first and second axes are not parallel to each other.

7. The ruggedized sensor window apparatus of claim 1 wherein the protective window comprises protective polycarbonate.

8. The ruggedized sensor window apparatus of claim 1 wherein:
the protective window is a thin substrate configured to avoid light scatter; and
the protective window and the light scatter blocking component are configured to be positioned in physical contact with the optical sensor.

9. The ruggedized sensor window apparatus of claim 8 wherein the protective window has a thickness of at most 8 mm.

10. The ruggedized sensor window apparatus of claim 1 wherein:
the protective window has a recessed portion surrounding the transmission component; and
the light scatter blocking component is positioned in the recessed portion.

11. The ruggedized sensor window apparatus of claim 1 wherein:
the protective window is spaced apart from the sensor by a distance; and
the light scatter blocking component has a thickness defined by the distance between the protective window and a front surface of the optical sensor.

12. The ruggedized sensor window apparatus of claim 1 wherein the protective window has a thickness of at least 10 mm.

13. A ruggedized sensor assembly, comprising:
a sensor having a transmission component and a receiver component;
a protective window positioned forward of the transmission and receiver components of the sensor, wherein the protective window is optically transparent;
a light scatter blocking component between at least a portion of the sensor and the protective window, wherein the light scatter blocking component has an aperture positioned surrounding the transmission component to allow transmission of signals therefrom, and wherein the light scatter blocking component is configured to block scatter from the transmission component from reaching the receiver component.

14. The ruggedized sensor assembly of claim 13 wherein the sensor is a laser distance sensor.

15. The ruggedized sensor assembly of claim 13 wherein:
the protective window comprises a recessed portion; and
the light scatter blocking component is positioned within the recessed portion.

16. The ruggedized sensor assembly of claim 13 wherein the window comprises polycarbonate.

17. The ruggedized sensor assembly of claim 13 wherein the window has a thickness between 4 mm and 8 mm.

18. The ruggedized sensor assembly of claim 13 wherein the window has a thickness between 8 mm and 20 mm.

19. The ruggedized sensor assembly of claim 13 wherein the aperture is a first aperture, wherein the light scatter blocking component has a second aperture positioned surrounding the receiver component to allow transmission of signals therefrom.

20. The ruggedized sensor assembly of claim 19 wherein the first aperture extends along a first axis, the second aperture extends along a second axis, and the first axis and the second axis are offset from each other by an angle between 1 degree and 5 degrees.

21. A method of ruggedizing a sensor, the method comprising:
positioning a protective window forward of the sensor intersecting an optical path of a transmission component and a receiver component of the sensor; and
positioning a light scatter blocking component between the protective window and the sensor, wherein the light scatter blocking component has a first side and a second side opposite the first side, and wherein the light scatter blocking component has an aperture extending completely through the light scatter blocking component from the first side to the second side,
wherein the aperture is configured to be positioned over the transmission component of the sensor to allow transmission of a sender beam to pass therethrough, and
wherein the light scatter blocking component is opaque and has a low reflection coefficient to block light scattering from the sender beam from reaching the receiver component of the sensor.

22. The method of claim 21 wherein:
the protective window has a recessed portion surrounding the transmission component; and
the light scatter blocking component is positioned in the recessed portion.

23. The method of claim 21 wherein the light scatter blocking component comprises ethylene propylene diene monomer (EPDM) or black polylactic acid (PLA).

24. The method of claim 21 wherein the aperture is a first aperture, and wherein the light scatter blocking component further comprises:
a second aperture extending through the light scatter blocking component from the first side to the second side, wherein the second aperture is configured to be positioned over the receiver component of the optical sensor to allow the receiver component to detect reflected light,
wherein the second aperture is spaced laterally apart from the first aperture by a distance.

25. The method of claim 24 wherein the first aperture extends along a first axis, the second aperture extends along a second axis, and the first axis and the second axis are offset from each other by an angle between 1 degree and 5 degrees.
